(19) United States
(12) Patent Application Publication
(10) Pub. No.: US 2026/0110440 A1
(43) Pub. Date: Apr. 23, 2026

(54) DEVICE FOR GUIDING A PUSH ELEMENT

(71) Applicant: GRASS GMBH, Höchst (AT)

(72) Inventor: Thomas TRAUNER, Salzburg (AT)

(73) Assignee: GRASS GMBH, Höchst (AT)

(21) Appl. No.: 19/424,606

(22) Filed: Dec. 18, 2025

Related U.S. Application Data
(63) Continuation of application No. PCT/EP2024/067816, filed on Jun. 25, 2024.

(30) Foreign Application Priority Data
Jul. 3, 2023 (DE) 10 2023 117 515.7

(51) Int. Cl. F24C 15/16

(52) U.S. Cl. CPC F24C 15/168

(57) ABSTRACT

The invention relates to a device for guiding a push element which can be movably received on a wall portion by means of the device, wherein the device comprises a fixed rail, which can be attached to the wall portion, and a movable rail, which can be associated with the push element, wherein one rail is movable relative to the other rail. According to the invention, the device comprises at least one sliding element, wherein the sliding element is made of an inorganic solid lubricant, wherein the sliding element is fixed on one rail of the device and is supported on the other rail.

### CROSS REFERENCE TO RELATED APPLICATIONS

This application is a continuation of International Application No. PCT/EP2024/067816 filed Jun. 25, 2024, which designated the United States, and claims the benefit under 35 USC § 119(a)-(d) of German Application No. 10 2023 117 515.7 filed Jul. 3, 2023, the entireties of which are incorporated herein by reference.

### FIELD OF THE INVENTION

The present invention relates to a device for guiding a push element.

### BACKGROUND OF THE INVENTION

Devices for guiding a slide element, in particular for kitchen appliances, such as ovens or microwaves, are already known in a wide variety of forms.

Furthermore, it is known to use a solid lubricant, such as graphite, as a lubricant. In known devices, the lubricant is applied to a running web of the device. The disadvantage of this is that the lubricant is washed off the running webs after the kitchen appliance has been cleaned a plurality of times.

### SUMMARY OF THE INVENTION

The object of the present invention is to provide an alternative device for guiding a slide element, which is used, in particular, in an oven, microwave cooking appliance or microwave oven.

The present invention starts from a device for guiding a slide element, which can be displaceably received on a wall portion by means of the device, wherein the device comprises a fixed rail, which can be fastened to the wall portion, and a movable rail, which can be allocated to the slide element, wherein one rail is provided so as to be movable relative to the other rail.

For example, the household appliance or item of furniture has two lateral walls which run vertically. The lateral walls have, for example, wall portions, wherein the device or the fixed rail of the device can be fastened to a wall portion. It is further conceivable that the device or the fixed rail is attachable to a lateral grid, associated with the wall portion, of an oven. For example, the lateral grid has, for example, a plurality of bars running horizontally, wherein the lateral grid projects, in particular slightly, from a wall surface of the wall portion. The lateral grids may, for example, be detachably inserted into the respective lateral walls or wall portions.

To displaceably guide the slide element, for example, two devices are provided, each being attached laterally to the slide element and to the associated lateral wall or wall portion. For example, the slide element or the lateral edges of the slide element may be placed on the movable rails of the devices. For example, the slide element is placed on the movable rail or is lifted off the latter in order to be taken out. The fixed rails of the devices are each connected, for example, to a wall portion of the opposing lateral walls.

The slide element is, for example, a food support, a baking rack, a baking tray, a pull-out shelf or a drawer.

The device is optionally formed as a fully extending runner with a central rail between the fixed rail and the movable rail.

It is common practice for the rails of the device to be formed as profiles made of bent sheet metal material, for example, as C-profiles or U-profiles.

The essence of the present invention is that the device comprises at least one anti-friction element, wherein the anti-friction element is made of an inorganic solid lubricant, wherein the anti-friction element is arranged in a fixed manner on one rail of the device and is supported on the other rail.

Since the anti-friction element is made of an inorganic solid lubricant, it is possible, for example, for the rails to be lubricated by the movement of the rails relative to each other. For example, a small part of the solid lubricant is drawn off the anti-friction element by the friction of the rails on the anti-friction element. The movement of the slide element or the movable rail relative to the fixed rail causes, for example, particles that have been rubbed off from the solid lubricant to be distributed onto the rails. This improves, for example, the sliding capacity of the rails.

For example, the anti-friction element is arranged on the fixed rail and is supported on the movable rail. It is further conceivable that the anti-friction element is arranged on the movable rail and is supported on the fixed rail. For example, the anti-friction element is connected in a fixed manner to the fixed rail. It is further conceivable that the anti-friction element is connected in a fixed manner to the movable rail.

It is further imaginable that the anti-friction element comprises graphite.

The device can preferably be arranged in ovens, for example, in pyrolysis-capable ovens. In this case, it is crucial that the anti-friction element is suitable, for example, for temperatures of 400° C. to 600° C. Advantageously, graphite is stable at high temperatures, so graphite can be employed as a lubricant in pyrolysis-capable ovens.

Furthermore, graphite is also stable, for example, at low temperatures. Graphite is, for example, food safe. An advantageous property of graphite is that it is, for example, resistant to common dishwashing detergents. Although graphite is removed from the rail during washing, the rails can be re-coated with graphite when the movable rail is moved relative to the fixed rail.

For example, the rate of wear of the graphite in the anti-friction element is very low, which renders the anti-friction elements highly durable. This ensures long-term lubrication of the rails.

For example, at least one anti-friction element is provided, wherein the anti-friction element comprises graphite or is made entirely of graphite. It is further conceivable that exactly two or exactly four anti-friction elements are provided. For example, all anti-friction elements comprise graphite or are made entirely of graphite.

For example, the rails each have a base portion which is adjoined, on the same side and at respective opposing ends of the base portion, by running webs which, as viewed in a cross section perpendicular to a longitudinal extent of the rails, project laterally and extend away from the base portion.

For example, the rails are nested in each other, with intermediate anti-friction elements, in such a way that a running web of one rail overlaps a running web of the other rail transversely to a longitudinal extent of the rails, and wherein each rail has an outer and an inner running web. This manner of nesting, of, for example, a fixed rail and a movable rail, makes it possible to shield, for example, an interior of the device from an external microwave source. Moreover, a particularly compact configuration in terms of vertical extent is achieved, for example, as a result of the manner of nesting in the installation position.

For example, a running web of the movable rail is arranged between the running webs of the fixed rail. It is also conceivable that a running web of the fixed rail is arranged between the running webs of the movable rail.

The rails, for example, each have a C-profile as viewed in cross section. However, another shape is also conceivable, in particular, for example, a U-profile in each case, so that, for example, the fixed rail and the movable rail are nested correspondingly in each other as U-profiles.

For example, the rails are of identical construction. It is further conceivable that the rails are arranged mirror-symmetrically to each other in the installation position. It is further conceivable that the rails are, for example, of identical construction in their extent from one running web to the opposing running web.

The base portion has, for example, a planar construction. It is advantageous if the respective base portion is oriented vertically in an intended installation position of the device. For example, in the mounted state, the base portions of the rails face each other and are, for example, both oriented vertically, in particular parallel, and, in particular, the base portions are exactly perpendicular in the installation position. It is conceivable that the base portion of the fixed rail is arranged on the wall portion.

For example, the anti-friction element is arranged on the base portion. It is conceivable that the anti-friction element is connected in a fixed manner to the base portion of a rail. In this case, the anti-friction element may be secured in a fixed manner to the base portion, for example, press-fitted, riveted or welded in. It is further possible for a bearing element, for example, a cylindrical bolt or pin, to connect the anti-friction element to the rail. The bearing element is secured in a fixed manner, for example, to the base portion, for example, press-fitted, riveted or welded in.

For example, the longitudinal extent of the bearing element extends perpendicularly to the longitudinal extent of the base portion of the rail. For example, the bearing element projects from the base portion in the same direction as the running webs project from the base portion.

It is further conceivable that the anti-friction element has a contact surface which is adapted to the contour of the running web.

The running web has, for example, a channel-shaped construction, wherein the channel shape may be symmetrical or asymmetrical.

A channel-shaped running web portion extending in the longitudinal direction of the rail makes it possible, for example, to securely guide the anti-friction element or the contact surface of the anti-friction element, in particular, with respect to a lateral offset, in particular, perpendicularly to the longitudinal extent of the rails and/or perpendicularly to the vertical extent of the rails. This applies, in particular, if the contact surface of the anti-friction elements, which corresponds at least partially to the channel shape, as viewed in cross section, on its inner surface.

For example, the contour of the anti-friction element that comes into contact with the running web is the contact surface. It is further conceivable that the contact surface is in continuous contact with the running web. For example, the anti-friction element is arranged on the fixed rail, wherein the contact surface of the anti-friction element is in contact with the running web of the movable rail, in particular, in continuous contact with the running web of the movable rail. For example, the anti-friction element is arranged on the movable rail, wherein the contact surface of the anti-friction element is in contact with the running web of the fixed rail, in particular, in continuous contact with the running web of the fixed rail.

It is conceivable that the device has at least two anti-friction elements, wherein one anti-friction element is arranged on the fixed rail and is supported on the movable rail, wherein another anti-friction element is arranged on the movable rail and is supported on the fixed rail.

For example, the device has exactly two anti-friction elements.

For example, one anti-friction element is arranged, in particular, arranged in a fixed manner, on the base portion of the fixed rail and one anti-friction element is arranged, in particular, arranged in a fixed manner, on the base portion of the movable rail. It is further conceivable that both anti-friction elements are connected to the respective base portion by means of a bearing element. The longitudinal extents of the bearing elements run, for example, parallel to each other and perpendicularly to the base portion of the fixed rail.

It is conceivable that the contact surface of the anti-friction element on the fixed rail is in continuous contact with the running web of the movable rail, and that the contact surface of the anti-friction element on the movable rail is in continuous contact with the running web of the fixed rail.

For example, the anti-friction elements are arranged at different ends of the fixed rail or movable rail in the closed state of the device. It is further conceivable that, in the closed state of the device, the anti-friction element on the fixed rail is arranged at one end of the fixed rail and the anti-friction element on the movable rail is arranged at the opposite end to the anti-friction element on the fixed rail.

For example, in the arranged, closed state of the device on the household appliance or item of furniture, the anti-friction element on the movable rail is arranged in the direction of the rear wall of the household appliance, for example oven, or of the furniture carcass. For example, in the arranged, closed state of the device on the household appliance or item of furniture, the other anti-friction element on the fixed rail is arranged in the direction of the opening of the household appliance or of the movable part of the item of furniture, for example, the oven door.

For example, the anti-friction element on the movable rail is also moved when the slide element is moved. When the movable rail is moved, for example, the anti-friction element on the movable rail is continuously supported on the running web of the fixed rail. Furthermore, when the movable rail is moved, the anti-friction element on the fixed rail is continuously supported on the running web of the movable rail, wherein the anti-friction element on the fixed rail is not moved.

For example, in the open state of the device, the anti-friction elements are arranged side by side, as viewed in the direction of the longitudinal extent of the base portion. It is further conceivable that the distance between the two anti-friction elements increases when the slide element is closed.

It is likewise conceivable that the device has at least four anti-friction elements, wherein two anti-friction elements are arranged on the fixed rail and are supported on the movable rail, wherein the other two anti-friction elements are arranged on the movable rail and are supported on the fixed rail.

For example, the device has exactly four anti-friction elements.

For example, two anti-friction elements are arranged on the base portion of the fixed rail. In this case, preferably both anti-friction elements are each fastened by a bearing element to the fixed rail. The longitudinal extents of the bearing elements run, for example, parallel to each other and perpendicularly to the base portion of the fixed rail.

It is further conceivable that two anti-friction elements are arranged on the base portion of the movable rail. In this case, preferably both anti-friction elements are each fastened by a bearing element to the movable rail. The longitudinal extents of the bearing elements run, for example, parallel to each other and perpendicularly to the base portion of the movable rail. For example, all longitudinal extents of the bearing elements run parallel to one another.

For example, the two bearing elements, with which the anti-friction elements are fastened to the rail, are offset on a rail as viewed in the longitudinal direction of the rail. As viewed in the longitudinal direction, the bearing elements or centers of the cylindrical bearing elements are, therefore, preferably not in a line, and are rather offset in height. This makes it possible for the contact surfaces of the anti-friction elements to contact the running webs on their inner side.

Furthermore, for example, the centers of the bearing elements of the fixed rail, as viewed in the longitudinal direction of the rail, are offset perpendicularly from the centers of the bearing elements of the movable rail.

For example, the anti-friction elements are arranged at different ends of the fixed rail or movable rail in the closed state of the device. It is further conceivable that, in the closed state, the two anti-friction elements on the fixed rail are arranged at one end of the fixed rail and the two anti-friction elements on the movable rail are arranged at the opposite end to the anti-friction elements on the fixed rail.

For example, in the arranged, closed state of the device on the household appliance or item of furniture, the two anti-friction elements on the movable rail are arranged in the direction of the rear wall of the household appliance, for example oven, or of the furniture carcass. For example, in the arranged, closed state of the device on the household appliance or item of furniture, the other two anti-friction elements on the fixed rail are arranged in the direction of the opening of the household appliance or of the movable part of the item of furniture, for example the oven door.

For example, the two anti-friction elements on the movable rail are also moved when the slide element is moved. When the slide element or movable rail with the anti-friction elements is moved, for example, the two anti-friction elements on the movable rail are continuously supported on the running web or running webs of the fixed rail. Furthermore, when the movable rail is moved, the two anti-friction elements on the fixed rail are continuously supported on the running web or running webs of the movable rail, wherein the two anti-friction elements on the fixed rail are not moved.

For example, in the open state of the device, the anti-friction elements are arranged side by side, as viewed in the direction of the longitudinal extent of the base portion. The distance between the two anti-friction elements on the movable rail and the two anti-friction elements on the fixed rail increases, for example, when the slide element is closed.

For example, two anti-friction elements are arranged on the fixed rail, wherein one anti-friction element is supported on a first running web of the movable rail and a further anti-friction element is supported on a second running web of the movable rail.

For example, the first running web of the movable rail is arranged between the two running webs of the fixed rail. The first running web of the movable rail is, for example, an inner running web. Furthermore, for example, the second running web of the movable rail is an outer running web.

For example, the anti-friction elements are of uniform construction. For example, the anti-friction elements are arranged at a distance from one another on the fixed rail in the longitudinal direction of the running webs or along the opening and closing direction of the slide element. The mutual distance between the anti-friction elements is preferably comparatively small.

Preferably, the contact surfaces of the anti-friction elements on the fixed rail are oriented in opposite directions. For example, the contact surface of a first anti-friction element of the fixed rail contacts, in particular continuously, the first running web of the movable rail, and the contact surface of the second anti-friction element of the fixed rail contacts, in particular continuously, the second running web of the movable rail.

It is likewise conceivable that two anti-friction elements are arranged on the movable rail, wherein one anti-friction element is supported on a first running web of the fixed rail and a further anti-friction element is supported on a second running web of the fixed rail.

For example, the first running web of the fixed rail is arranged between the two running webs of the movable rail. In this case, the first running web of the fixed rail is, for example, an inner running web. Furthermore, for example, the second running web of the fixed rail is an outer running web.

For example, the anti-friction elements are of uniform construction. For example, the anti-friction elements are arranged at a distance from one another on the movable rail in the longitudinal direction of the running webs or along the opening and closing direction of the slide element. The mutual distance between the anti-friction elements is preferably comparatively small.

Preferably, the contact surfaces of the anti-friction elements on the movable rail are oriented in opposite directions. For example, the contact surface of a first anti-friction element of the movable rail contacts, in particular continuously, the first running web of the fixed rail, and the contact surface of the second anti-friction element of the movable rail contacts, in particular continuously, the second running web of the fixed rail.

It is likewise conceivable that the anti-friction element has an attachment body which is attachable to the rail.

For example, the attachment body has a cuboid-shaped construction. For example, the attachment body has a cylindrical recess, through which a bearing element may be inserted. For example, the attachment body is connected to the rail, in particular, to the base portion of the rail, via the bearing element.

It is also conceivable that the attachment body has two projections projecting out from the attachment body. The projections are, for example, of cylindrical construction. The projections may, for example, serve as spacers. For example, the projections are constructed on the side of the attachment body connected to the rail. The diameter of the circular base surface of the cylindrical projections and the cylindrical recess is, for example, the same. It is further conceivable that the centers of the circular base surfaces of the projections and the cylindrical recess lie on a line which is, for example, horizontal in the arranged state of the device.

For example, the anti-friction element has a contact body, wherein the contact surface is formed on the contact body.

The contact body is formed, for example, as a triangular prism. In this case, for example, one tip is rounded, this tip being matched, for example, to the contour of the running web, which is, for example, channel-shaped. It is also conceivable that the surfaces adjacent to the rounded tip partly contact the running web. In this case, for example, the surfaces of the contact body that contact the running web form the contact surfaces.

It is conceivable that the device comprises a retaining element, wherein the retaining element is arranged on the fixed rail, wherein the retaining element can be fastened to the wall portion.

The retaining element is, for example, L-shaped or U-shaped. The retaining element is connected, for example, in a fixed manner to the fixed rail, wherein the retaining element can be connected to the running web and/or base portion. The retaining element has, for example, sockets for fastening mechanisms, such as screws.

For example, a running web of a rail has a cut-out, wherein, for example, the contact body and a part of the attachment body of a single anti-friction element protrude through the cut-out.

For example, the cut-out has a length corresponding to the length of at least one anti-friction element. It is further conceivable that the length of the cut-out corresponds to the length of two anti-friction elements. It is also conceivable that the cut-out begins at the end portion of a rail and extends to the end of the second anti-friction element located further away from the end portion of the rail.

For example, a running web of the fixed rail and a running web of the movable rail have a cut-out. For example, the first running web of the fixed rail and the first running web of the movable rail each have a cut-out. For example, the cut-outs are oriented in opposite directions.

A further aspect of the present invention is a slide element, which can be movably arranged on a wall portion, with a device according to any one of the above embodiments.

In a further essential aspect of the present invention, a household appliance or item of furniture is equipped with a device according to any one of the above embodiments.

For example, the household appliance or item of furniture has two opposing devices. The device enables a slide element to be slid into or out of the household appliance or item of furniture.

### BRIEF DESCRIPTION OF THE DRAWINGS

Further features and advantages of the present invention are explained in more detail with reference to an exemplary embodiment illustrated schematically in the figures.

FIG. 1 shows a perspective view from an oblique lateral angle of a household appliance with a device according to the present invention arranged on a wall portion;

FIG. 2 shows a perspective view of an anti-friction element of the device;

FIG. 3 shows a three-dimensional illustration of a device as shown in FIG. 1, in the closed state;

FIG. 4 shows a side view of an end region of a rail of the device as shown in FIG. 1;

FIG. 5 shows a three-dimensional illustration of an end region of a rail of the device as shown in FIG. 3, wherein the base portion is illustrated in a transparent manner;

FIG. 6 shows a side view of a device as shown in FIG. 1 in the open state;

FIG. 7 shows a side view of a detail A as shown in FIG. 6; and

FIG. 8 shows a three-dimensional illustration of a portion of the device as shown in FIG. 7.

### DETAILED DESCRIPTION OF THE INVENTION

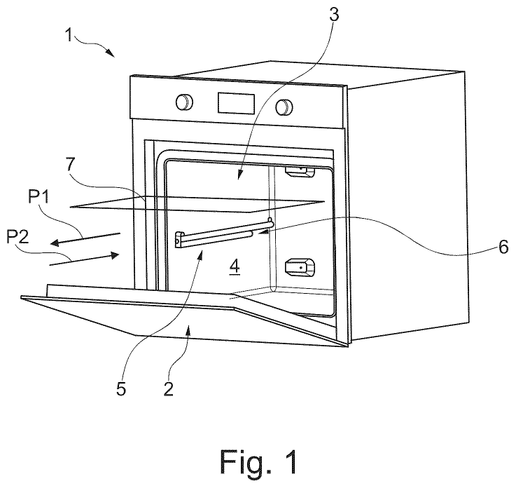

FIG. 1 shows a household appliance 1, for example, an oven, with a partly swung-open door 2, for example an oven door, so that the interior with the oven cavity 3 is visible. The oven cavity 3 has two opposing lateral walls 4 with wall portions 5, wherein a device 6 is arranged on each of the wall portions 5. A common slide element 7, such as a baking tray, may be placed on the two devices 6 attached in this manner. To receive the slide element 7 in the oven cavity 3, a respective edge portion of opposing lateral edges of the slide element 7, i.e., a right-hand edge and a left-hand edge of the slide element 7, is supported on the respective device 6. The slide element 7 is supported on both sides from the underside by a respective upper horizontal running web of a movable rail 8, which extends over the entire length of the device 1.

To limit a potential relative movement of the edge portion, placed on the running web, of the slide element 7 on the device 1, limiters 9 and 10 are provided at the two end regions of the device 6 (see FIG. 3). The limiters 9, 10 positioned at the ends are formed by vertically upright limiting elements, such as bolts.

The device 6 is formed in this case as a partially extending runner. The device 6 comprises, for example, a fixed rail 11 and a movable rail 8, each made of a sheet metal material. The slide element 7 is displaceably arranged by means of the movable rail 8. The movable rail 8, together with the slide element 7, can be moved relative to the fixed rail 11 in the opening direction P1 and closing direction P2. The device 6 is shown in FIG. 1 with the movable rail 8 and the fixed rail 11 fully pushed together.

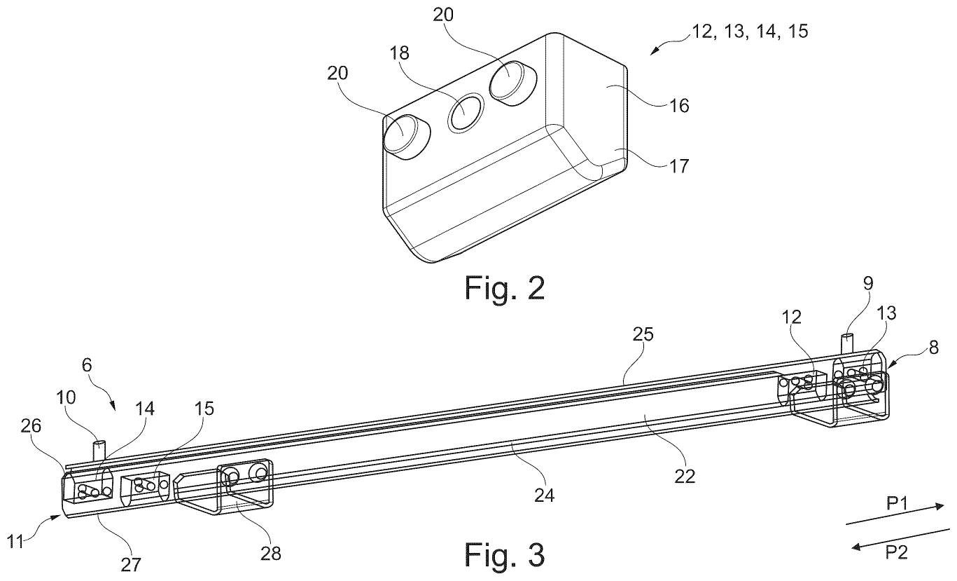

At least one anti-friction element 12, 13, 14, 15 is arranged on each of the rails 8, 11 of the device 6. The anti-friction element (see FIG. 2) comprises, for example, graphite or is made completely of graphite. For example, all anti-friction elements 12, 13, 14, 15 are completely made of graphite or comprise graphite. This allows the rails 8, 11 to be lubricated when the movable rail 8 moves relative to the fixed rail 11.

For example, the anti-friction element 12 has an attachment body 16 and a contact body 17. The attachment body 16 has, for example, a cuboid-shaped construction, wherein, for example, some borders are rounded.

The attachment body 16 has, for example, a cylindrical recess 18 in which a bearing element 19 can be received, for example the anti-friction element 12, 13, 14, 15 can be connected, in particular connected in a fixed manner, to a rail 8, 11 by means of the bearing element 19 (see FIG. 5).

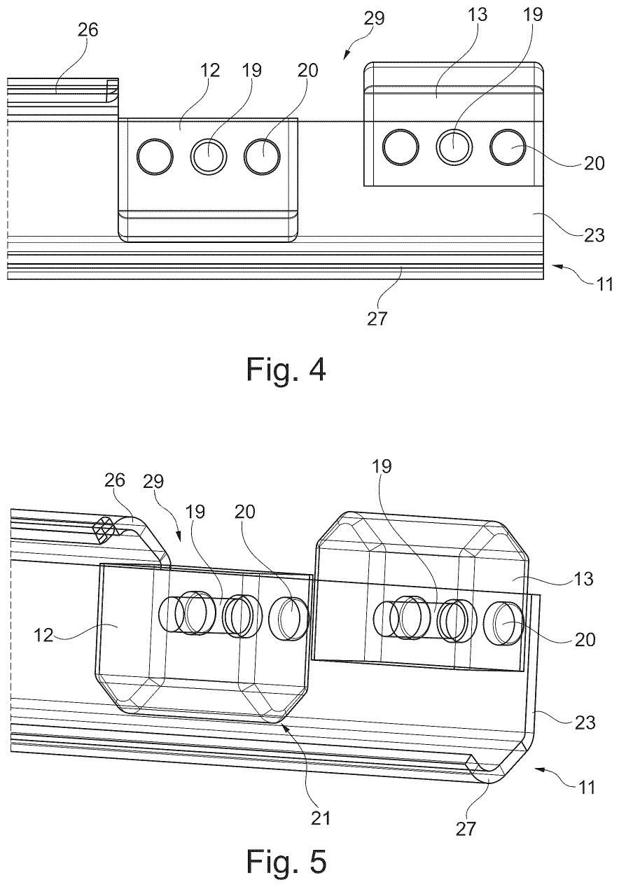

For example, the attachment body 16 has at least one projection 20, preferably exactly two projections 20. The projections 20 are, for example, cylindrical. For example, the projections 20 are formed on the outer surface of the attachment body 16, with which the attachment body 16 is fastened to the rail 8, 11. For example, the projections 20 are used to establish a distance to the rail 8, 11, to which the anti-friction element 12, 13, 14, 15 is attached. It is conceivable that the centers of the circular base surfaces of the cylindrical recess 18 and the projections 20 form a line (see FIG. 4). For example, the line runs parallel to the opening direction P1 and closing direction P2 (see FIG. 7).

For example, the center of the bearing element 19 of the anti-friction element 12 is offset, perpendicularly to the longitudinal extent of the base portion 23, from the center of the bearing element 19 of the anti-friction element 13 (see FIG. 4). For example, the center of the bearing element 19 of the anti-friction element 14 is offset, perpendicularly to the longitudinal extent of the base portion 22, from the center of the bearing element 19 of the anti-friction element 15 (see FIG. 7). It is also conceivable that the centers of the bearing elements 19 of the anti-friction elements 12, 13, 14, 15 are all offset from one another perpendicularly to the opening direction P1 and closing direction P2 or have different heights (see FIG. 7).

Furthermore, the anti-friction element 12, 13, 14, 15 has a contact body 17, which adjoins a side of the attachment body 16. The contact body 17 is formed, for example, as a triangular prism. In this case, for example, one tip of the contact body 17 is rounded, wherein, for example, the rounded tip contacts the rail 8, 11, in particular a running web of the rail 8, 11. The surfaces of the contact body 17 that, during the opening and closing movement of the slide element 7, are supported on the rail 8, 11, on which the anti-friction element 12, 13, 14, 15 is not arranged, are, for example, the contact surfaces 21.

FIG. 3 shows the device 6 in the closed position. The movable rail 8 and the fixed rail 11 are, for example, C-shaped. The rails have, for example, in each case, a base portion 22, 23 and a running web 24, 25, 26, 27. In this case, for example, the running webs 24, 25 of the movable rail 8 project, on one side, from the base portion 22 in the direction of the fixed rail 11. Furthermore, the running webs 26, 27 projecting from the base portion 23 of the fixed rail 11 project, for example, on one side, in the direction of the movable rail 8. In this case, the rails 8, 11 are, for example, nested in each other, wherein, for example, arranged between the running webs 24, 25 of the movable rail 8 is the first running web 26 of the fixed rail 11, and arranged between the running webs 26, 27 of the fixed rail 11 is the first running web 24 of the movable rail 8. Furthermore, for example, the lowest second running web 27 of the fixed rail 11 overlaps the first running web 24 of the movable rail 8 on the underside. For example, the uppermost second running web 25 of the movable rail 8 overlaps the first running web 26 of the fixed rail 11 at the top.

The base portion 23 of the fixed rail 11 may be arranged, for example, directly on a wall portion 5 of the inner wall 4 of the oven cavity 3. It is further conceivable that the base portion 23 may be arranged on a lateral grid which is connected to the wall portion 5. Furthermore, a retaining element 28 may be connected to the fixed rail 11 in order to connect, for example, in a fixed manner, the fixed rail 11 to the wall portion 5. It is also conceivable that the retaining element 28 is connected to the lateral grid. The retaining element 28 may, for example, be connected to the running web 25 and/or base portion 23 of the fixed rail 11. The retaining element 28 has, for example, sockets for a fastening means, such as screws.

For example, in each case two anti-friction elements 12, 13, 14, 15 are arranged on the fixed rail 11 and movable rail 8. In this case, for example, the anti-friction elements 12, 13 are connected to the base portion 23 of the fixed rail 11 and the anti-friction elements 14, 15 are connected to the base portion 22 of the movable rail 8. The anti-friction elements 12, 13, 14, 15 may be connected, for example, by means of the bearing elements 19 to the rails 8, 11 (see FIG. 8).

In the arranged, closed state of the device 6 on the household appliance 1, for example, the anti-friction elements 12, of the fixed rail 11 are arranged on the fixed rail 11 in the direction of the opening or the door 2 of the household appliance 1. Furthermore, for example, in the arranged, closed state of the device 6 on the household appliance 1, the two anti-friction elements 14, 15 of the movable rail 8 are arranged on the movable rail 8 in the direction of the rear wall of the household appliance 1.

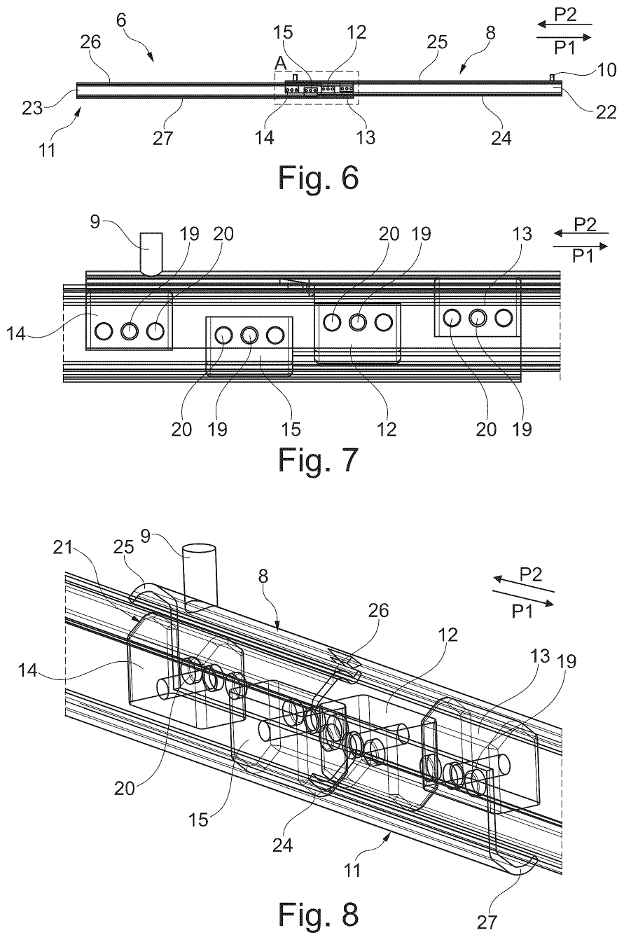

Therefore, for example, the movable rail 8 may be moved in the opening direction P1 until the anti-friction elements 12, 13, 14, 15 of the two rails 8, 11 meet (see FIG. 6). In this case, for example, the anti-friction element 15 of the movable rail 8 is adjacent to the anti-friction element 12 of the fixed rail 11.

A contact surface 21 of the first anti-friction element on the fixed rail 11 is supported, for example, on the first running web 24 of the movable rail 8, and the contact surface 21 of the second anti-friction element 13 on the fixed rail 11 is supported, for example, on the second running web 25 of the movable rail 8. It is further conceivable that the contact surface 21 of the first anti-friction element 14 on the movable rail 8 is supported, for example, on the first running web 26 of the fixed rail 11, and the contact surface of the second anti-friction element 15 on the movable rail 8 is supported, for example, on the second running web 27 of the fixed rail 11. In each case, the contact surfaces 21 of the anti-friction elements 12, 13, 14, 15 contact, in particular continuously, for example, the running surfaces 24, 25, 26, 27 of the rails 8, 11.

An end region of a rail 11 is illustrated in FIGS. 4 and 5. The figures show that, for example, the first running web 26 has a cut-out 29. In this case, the contact surface 21 of the second anti-friction element 13 on the fixed rail 11 juts out, for example, beyond the running web 26 so that the contact surface 21 of the anti-friction element 13 reaches the second running web 25 of the movable rail 8. The contact surface 21 of the anti-friction element 15 on the movable rail 8 also juts out, for example, beyond the first running web 24 of the movable rail 8 so that the contact surface 21 of the anti-friction element 15 reaches the second running web 27 of the fixed rail 11 (see FIGS. 3, 8). The only reason the contact surfaces 21 of the anti-friction elements 13, 15 of one rail 8, 11 are able to reach the running webs 25, 27 of the other rail 8, 11 is because, for example, the running webs 24, 26 have a cut-out 29. The length of the cut-out 29 is therefore to be, for example, at least the length of an anti-friction element. Preferably, the cut-out 29 extends from one end of the rail 8, 11 to the end of the anti-friction element 12, 15 furthest away from the end of the rail 8, 11.

During the opening movement of the slide element 7 or of the movable rail 8, for example, the anti-friction elements 14, 15 on the movable rail are moved in the opening direction P1. In so doing, for example, the contact surface 21 of the first anti-friction element 14 of the movable rail 8 contacts the first running web 26 of the fixed rail 11, and the contact surface 21 of the second anti-friction element 15 of the movable rail 8 contacts the second running web 27 of the fixed rail 11. In this process, for example, as a result of the friction of the fixed rail 11 on the anti-friction elements 14, 15 of the movable rail 8, graphite particles are distributed onto the running webs 26, 27 of the fixed rail 11. Furthermore, for example, during the opening movement of the slide element 7, the anti-friction elements 12, 13 of the fixed rail 11 remain stationary, wherein the running webs 24, 25 of the movable rail 8 are moved in the opening direction P1. In so doing, for example, the contact surface 21 of the first anti-friction element 12 of the fixed rail 11 contacts the first running web 24 of the movable rail 8, and the contact surface 21 of the second anti-friction element 13 of the fixed rail 11 contacts the second running web 25 of the movable rail 8. In this process, for example, as a result of the friction of the movable rail 8 on the anti-friction elements 12, 13 of the fixed rail 11, graphite particles are distributed onto the running webs 24, 25 of the movable rail 8.

### LIST OF REFERENCE SIGNS

1 Household appliance
2 Door
3 Oven cavity
4 Inner wall
5 Wall portion
6 Device
7 Slide element
8 Rail
9 Limiting element
10 Limiting element
11 Rail
12 Anti-friction element
13 Anti-friction element
14 Anti-friction element
15 Anti-friction element
16 Attachment body
17 Contact body
18 Recess
19 Bearing element
20 Projection
21 Contact surface
22 Base portion
23 Base portion
24 Running web
25 Running web
26 Running web
27 Running web
28 Retaining element
29 Cut-out

1. A device for guiding a slide element, which can be displaceably received on a wall portion by means of the device, wherein the device comprises a fixed rail, which can be fastened to the wall portion, and a movable rail, which can be allocated to the slide element, wherein one rail is provided so as to be movable relative to the other rail, wherein the device comprises at least one anti-friction element, wherein the anti-friction element is made of an inorganic solid lubricant, wherein the anti-friction element is arranged in a fixed manner on one rail of the device and is supported on the other rail, wherein the rails each have a base portion which is adjoined, on the same side and at respective opposing ends of the base portion, by running webs which, as viewed in a cross section perpendicular to a longitudinal extent of the rails, project laterally and extend away from the base portion, wherein a running web of the fixed rail and a running web of the movable rail have a cut-out, wherein the cut-out has a length corresponding to the length of at least one anti-friction element.

2. The device as claimed in claim 1, wherein the anti-friction element comprises graphite.

3. The device as claimed in claim 1, wherein the anti-friction element has a contact surface which is adapted to the contour of the running web.

4. The device as claimed in claim 1, wherein the device has at least two anti-friction elements, wherein one anti-friction element is arranged on the fixed rail and is supported on the movable rail, wherein another anti-friction element is arranged on the movable rail and is supported on the fixed rail.

5. The device according to claim 1, wherein the device has at least four anti-friction elements, wherein two anti-friction elements are arranged on the fixed rail and are supported on the movable rail, wherein the other two anti-friction elements are arranged on the movable rail and are supported on the fixed rail.

6. The device as claimed in claim 1, wherein two anti-friction elements are arranged on the fixed rail, wherein one anti-friction element is supported on a first running web of the movable rail and a further anti-friction element is supported on a second running web of the movable rail.

7. The device as claimed in claim 1, wherein two anti-friction elements are arranged on the movable rail, wherein one anti-friction element is supported on a first running web of the fixed rail and a further anti-friction element is supported on a second running web of the fixed rail.

8. The device as claimed in claim 1, wherein the anti-friction element has an attachment body which is attachable to the rail.

9. The device as claimed in claim 1, wherein the anti-friction element has a contact body, wherein the contact surface is formed on the contact body.

10. The device as claimed in claim 1, wherein the device comprises a retaining element, wherein the retaining element is arranged on the fixed rail, wherein the retaining element can be fastened to the wall portion.

11. A slide element, which can be movably arranged on a wall portion, with a device as claimed in claim 1.

12. A household appliance or item of furniture with a device as claimed in claim 1.

13. A household appliance or item of furniture including the device as claimed in claim 1 for movably arranging a slide element on a wall portion of the household appliance or item of furniture.

14. A household appliance or item of furniture including the device as claimed in claim 2 for movably arranging a slide element on a wall portion of the household appliance or item of furniture.

15. A household appliance or item of furniture including the device as claimed in claim 3 for movably arranging a slide element on a wall portion of the household appliance or item of furniture.

16. A household appliance or item of furniture including the device as claimed in claim 4 for movably arranging a slide element on a wall portion of the household appliance or item of furniture.

17. A household appliance or item of furniture including the device as claimed in claim 5 for movably arranging a slide element on a wall portion of the household appliance or item of furniture.

18. A household appliance or item of furniture including the device as claimed in claim 6 for movably arranging a slide element on a wall portion of the household appliance or item of furniture.

19. A household appliance or item of furniture including the device as claimed in claim 7 for movably arranging a slide element on a wall portion of the household appliance or item of furniture.

20. A household appliance or item of furniture including the device as claimed in claim 8 for movably arranging a slide element on a wall portion of the household appliance or item of furniture.

21. A household appliance or item of furniture including the device as claimed in claim 9 for movably arranging a slide element on a wall portion of the household appliance or item of furniture.

22. A household appliance or item of furniture including the device as claimed in claim 10 for movably arranging a slide element on a wall portion of the household appliance or item of furniture.
